(19) United States
(12) Patent Application Publication
(10) Pub. No.: US 2014/0320670 A1
(43) Pub. Date: Oct. 30, 2014

(54) TEST DEVICE AND TEST METHOD FOR TESTING BUTTON FUNCTION OF REMOTE CONTROL

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/243,334

(22) Filed: Apr. 2, 2014

(30) Foreign Application Priority Data
Apr. 30, 2013 (CN) 2013101555224

(51) Int. Cl. H04N 17/00

(52) U.S. Cl. CPC H04N 17/00
USPC 348/180

(57) ABSTRACT

A test device for testing functions of buttons of a remote control includes a storage unit, a pressing apparatus, and a processing unit. Identification (ID) information of each of the buttons and a predetermined code corresponding to each of the buttons are stored in the storage unit. When a control signal is received from the remote control after a button is pressed, the control signal is decoded to obtain a code of the control signal and the ID information of the button, which is being pressed. The code of the control signal is compared with the predetermined code stored in the storage unit corresponding to the pressed button to determine whether the pressed button is malfunctional.

### FIELD

Embodiments of the present disclosure relate generally to test technologies of electronic devices, and particularly to a test device and a test method for testing button functions of a remote control.

### BACKGROUND

Remote controls are widely used to control various electronic devices, such as televisions, set top boxes (STB), and DVD players. A remote control may include a number of buttons to control the electronic device to perform different functions. During the manufacturing process of the remote control, it is very important to test the functions of the buttons. In a typical test method, the functions of the buttons are tested by manually pressing each button, and then a tester manually determining whether the electronic device performs corresponding functions. However, this manual test method is inconvenient and wastes time. Therefore, there is room for improvement in the art.

### BRIEF DESCRIPTION OF THE DRAWINGS

FIG. 1 is a schematic block diagram of a test device for testing a remote control.

FIG. 2 is a flowchart of one embodiment of a test method for testing the remote control using the test device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”. The reference “a plurality of” means “at least two”.

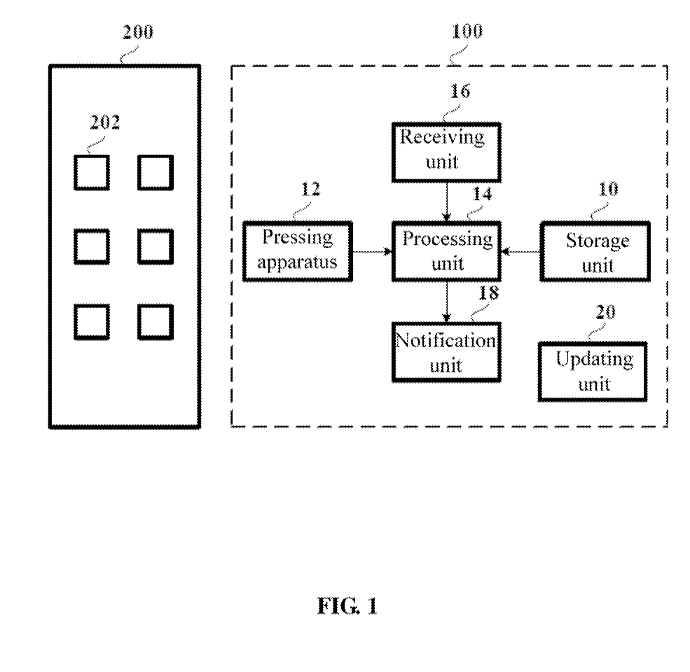

FIG. 1 is a schematic block diagram of a test device 100 for testing a remote control 200. The remote control 200 includes a plurality of buttons 202. When a button 202 is pressed, the remote control 200 emits a control signal including a code corresponding to the button 202. In this embodiment, the control signal is a radio signal such as an infrared (IR) signal. The code corresponding to each of the buttons 202 can be a pulse width modulated (PWM) code, which can be decoded and can be encoded by an electronic device controlled by the remote control 200. The remote control can be an

IR remote control or a BLUETOOTH® remote control. The test device 100 communicates with the remote control 200 via a wired connection or a wireless connection.

The test device 100 can include a storage unit 10, a pressing apparatus 12, a processing unit 14, a receiving unit 16, and a notification unit 18. The storage unit 10 stores identification (ID) information of each of the buttons 202 and a predetermined code corresponding to each of the buttons 202. The ID information of each button 202 can be a button name of each button 202. In at least one example, the remote control 100 is a remote control of a DVD player. The buttons 202 of the remote control may include a volume up button, a volume down button, a pause/play button, a power button, a backspace button, and other kind of buttons.

In at least one embodiment, the pressing apparatus 12 couples with the remote control 100. The pressing apparatus 12 is configured to be positioned on the remote control 100 to press each of the buttons 202 in turn at regular intervals.

In at least one embodiment, the receiving unit 16 is configured to receive control signals emitted by the remote control 100 when the buttons 202 are pressed by the pressing apparatus 12.

In at least one embodiment, the processing unit 14 detects whether a control signal emitted by the remote control 100 is received by the receiving unit 14 within a predetermined time period (e.g., three seconds) after a button 202 is pressed. When the control signal is received from the remote control 100, the processing unit 14 decodes the control signal to obtain a code of the control signal and the ID information of the button 202, which is pressed. In this embodiment, the predetermined time period is less than a time interval in which two of the buttons 202 are continuously pressed.

In at least one embodiment, the processing unit 14 further obtains the predetermined code corresponding to the pressed button 202 from the storage unit 10 according to the ID information of the pressed button 202, and compares the code of the control signal with the obtained predetermined code to determine whether the pressed button 202 is malfunctional. In this embodiment, when the code of the control signal is the same to the obtained predetermined code, the pressed button 202 is determined to be normal. Otherwise, the pressed button 202 is determined to be malfunctional.

In at least one embodiment, when the pressed button 202 is malfunctional, the notification unit 18 outputs a notification message to notify a user. In this embodiment, the notification message includes the ID information of the pressed button, reasons that cause the button 202 to be malfunctional, and solutions for eliminating the malfunction of the pressed button 202 such as changing a battery. The reasons that the pressed button 202 is malfunctional and the solutions for eliminating the malfunction of the pressed button 202 can be pre-stored in the storage unit 10.

Further, if the processing unit 14 detects that the receiving unit 16 has not received the control from the remote control 200 within the predetermined time period after the button 202 is pressed, the notification message is output by the notification unit 18. In this embodiment, the notification unit 18 can be a display such as an LCD for displaying the notification message.

In at least one embodiment, the test device 100 further includes a updating unit 20 having a network function to connect to a network. The updating module 20 can be configured to acquire the other reasons which may cause the buttons 202 to be malfunction and other solutions corresponding to the other reasons from the network, and stores the acquired other reasons and corresponding solutions in the storage unit 10.

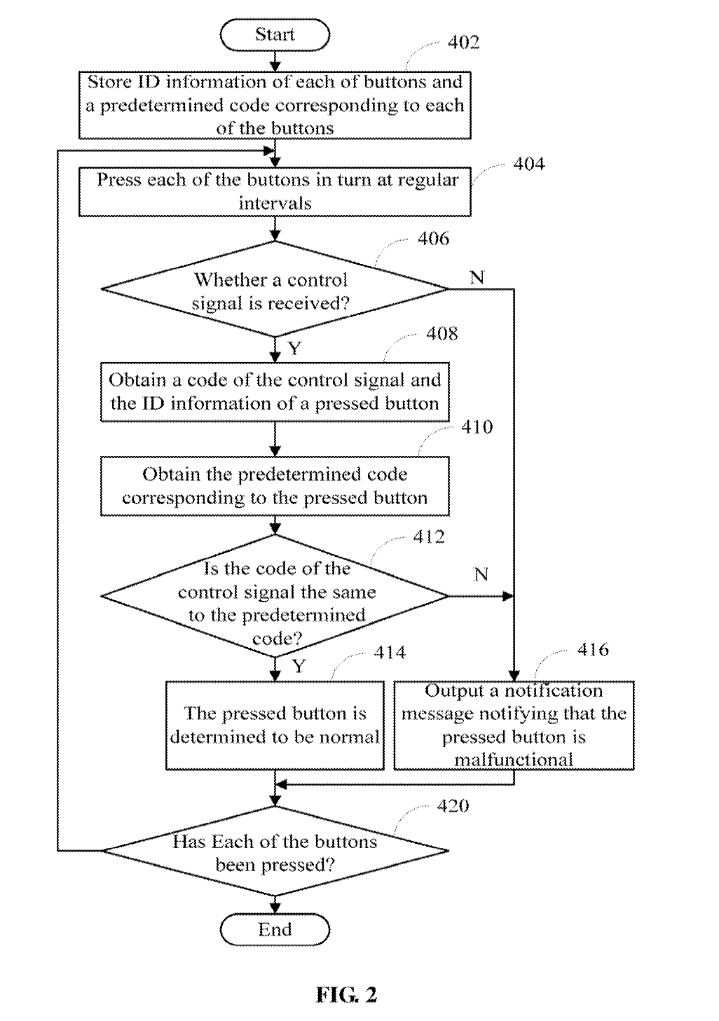

FIG. 2 is a flowchart of one embodiment of a test method for testing the remote control 200 using the test device 100 of FIG. 1. Depending on the embodiment, additional steps may be added, others removed, and the ordering of the steps may be changed.

In 402, the storage unit 10 stores identification (ID) information of each of the buttons 202 and a predetermined code corresponding to each of the buttons 202.

In 404, the pressing apparatus 12 presses each of the buttons 202 in turn at regular intervals.

In 406, when a button 202 is pressed, the processing unit 14 detects whether a control signal is received by the receiving unit 16 from the remote control 200 within a predetermined time period after the button 202 is pressed. If the control signal is received by the receiving unit 16 within the predetermined period after the button 202 is pressed, 408 is implemented. Otherwise, 416 is implemented.

In 408, the processing unit 14 decodes the control signal to obtain a code of the control signal and the ID information of the pressed button 202.

In 410, the processing unit 14 obtains the predetermined code corresponding to the pressed button 202 from the storage unit 10 according to the ID information of the pressed button 202.

In 412, the processing unit 14 determines whether the code of the control signal is the same to the obtained predetermined code. If the code of the control signal is the same to the obtained predetermined code, 414 is implemented. Otherwise, 416 is implemented.

In 414, the processing unit 14 determines that the pressed button 202 is normal, the procedure goes to 420.

In 416, the notification unit 18 outputs a notification message notifying that the pressed button is malfunctional.

In 420, the pressing unit 12 determines whether each of the buttons 202 has been pressed. If each of the buttons 202 has been pressed, the procedure ends. Otherwise, the procedure returns to 406.

Although certain embodiments of the present disclosure have been specifically described, the present disclosure is not to be construed as being limited thereto. Various changes or modifications may be made to the present disclosure without departing from the scope thereof. The embodiments described herein are illustrative only, and are not intended to limit the scope of the following claims.

What is claimed is:

1. A test device for testing functions of buttons of a remote control, comprising:
a storage unit storing identification (ID) information of each of the buttons and a predetermined code corresponding to each of the buttons;
a pressing apparatus configured to press each of the buttons in turn at regular intervals; and
a processing unit detecting whether a control signal is received from the remote control within a predetermined time period after a button is pressed, decoding the control signal to obtain a code of the control signal and the ID information of the button which is pressed when the control signal is received, and comparing the code of the control signal with the predetermined code stored in the storage unit corresponding to the pressed button to determine whether the pressed button is malfunctional.

2. The test device according to claim 1, further comprising a receiving unit configured to receive the control signal emitted by the remote control when the button is pressed by the pressing apparatus.

3. The test device according to claim 1, further comprising a notification unit configured to output a notification message to notify a user when the pressed button is determined to be malfunctional.

4. The test device according to claim 3, wherein the notification message comprises the ID information of the pressed button, reasons that cause the malfunction of the pressed button, and solutions for eliminating the malfunction of the pressed button.

5. The electronic device according to claim 4, wherein the reasons that cause the malfunction of the pressed button and the solutions for eliminating the malfunction are pre-stored in the storage unit.

6. The electronic device according to claim 4, further comprising a updating unit capable of connecting to a network, the updating unit is configured to acquire other reasons which cause the malfunction of the buttons and other solutions corresponding to the other reasons from the network, and to store the acquired other reasons and corresponding solutions in the storage unit.

7. The test device according to claim 3, wherein the notification unit is a display of the test device to display the notification message.

8. The test device according to claim 1, wherein the code corresponding to each of the buttons is a pulse width modulated code.

9. A method for testing functions of buttons of a remote control using a testing device, the method comprising:
storing identification (ID) information of each of the buttons and a predetermined code corresponding to each of the buttons using a storage unit of the test device;
pressing each of the buttons in turn at regular intervals using a pressing apparatus of the test device; and
detecting whether a control signal is received from the remote control within a predetermined time period after a button is pressed using a processing unit of the test device;
decoding, using the processing unit, the control signal to obtain a code of the control signal and the ID information of the button which is pressed when the control signal is received; and
comparing the code of the control signal with the predetermined code stored in the storage unit corresponding to the pressed button to determine whether the pressed button is malfunctional.

10. The method according to claim 9, further comprising:
receiving the control signal emitted by the remote control using a receiving unit of the test device, when the button is pressed by the pressing apparatus.

11. The method according to claim 9, further comprising:
outputting a notification message to notify a user using a notification unit of the test device when the pressed button is determined to be malfunctional.

12. The method according to claim 11, wherein the notification message comprises the ID information of the pressed button, reasons that cause the malfunction of the pressed button, and solutions for eliminating the malfunction of the pressed button.

13. The method according to claim 12, wherein the reasons that cause the malfunction of the pressed button and the solutions for eliminating the malfunction are pre-stored in the storage unit.

14. The method according to claim 12, further comprising:
acquiring the other reasons which cause the malfunction of the buttons and other solutions corresponding to the other reasons from a network and storing the acquired other reasons and corresponding solutions in the storage unit, using an updating unit of the test device.

15. The method according to claim 11, wherein the notification unit is a display of the test device to display the notification message.

16. The method according to claim 9, wherein the code corresponding to each of the buttons is a pulse width modulated code.
